(19) United States
(12) Patent Application Publication
(10) Pub. No.: US 2004/0206857 A1
(43) Pub. Date: Oct. 21, 2004

(54) Clamp for retaining a probe cable at a desired location and related methods

(76) Inventor: Andrew Harvey Barr, Roseville, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,493

(22) Filed: Apr. 16, 2003

(51) Int. Cl. F16L 3/08; F16L 3/12

(52) U.S. Cl. 248/74.1

(57) ABSTRACT

A clamp for retaining a probe cable out of a technician's way while he/she probes an electronic system includes a cable-retention element and a clamp-attachment element. The cable-retention element releasably holds a probe cable to the clamp, and the clamp-attachment element anchors the cable-retention element at a desired location. Consequently, the clamp can isolate the probe cable away from the technician's activities and keep excess probe cable from looping. This reduces the likelihood of damage caused by the technician unintentionally pulling the probe cable while probing an electrical circuit and increases the fidelity of the signal the oscilloscope receives. Furthermore the clamp-attachment element may releasably anchor the cable-retention element at a desired location to allow the clamp to be effectively reused many times.

### BACKGROUND OF THE INVENTION

Electronic systems, such as computers typically include at least one circuit board mounted inside a protective case. Each circuit board typically includes many electrical circuits and at least one component such as a processor, power supply or memory chip mounted to it. When these systems malfunction or their design is not complete, a technician typically probes the electrical circuits and components with an oscilloscope to determine the cause of the malfunction or to confirm the system operates as intended.

To probe the system, a technician connects a probe to the oscilloscope and probes a signal node with a tip of the probe. The probe cable—the cable that connects the probe to the body of the oscilloscope—is typically several feet long to allow a technician to maneuver the probe.

Unfortunately, a long probe cable can cause problems for a technician. For example, the extra length of the probe cable can be coiled or looped on or next to an electrical circuit or component of the electrical system. If the technician snags the loop with his arm, he/she could pull the probe cable damaging the electrical system, the probe, or the oscilloscope. In addition, such a cable loop can pick up noise from the electronic system or elsewhere, and the noise can adversely affect the fidelity of the probed signal received by the oscilloscope.

One method of retaining the probe cable out of the technician's way is to secure the probe cable to the electrical system with conventional tape. This solution, however, has some problems. Conventional tape often loses its ability to adhere to the electrical system after the tape has been removed a few times, and thus, the technician is limited in the number of times he/she can reuse it. Furthermore, as the tape nears its limit of effective use, it could prematurely release the probe cable, which the technician could then snag or unintentionally pull.

### SUMMARY OF THE INVENTION

In one aspect of the invention, a clamp for retaining a probe cable out of a technician's way while he/she probes an electrical circuit and/or component of an electronic system includes a cable-retention element and a clamp-attachment element. The cable-retention element releasably holds a probe cable to the clamp. The clamp-attachment element anchors the cable-retention element at a desired location. For example, the desired location can include a circuit board of the electronic system, a protective case housing the electronic system, an electronic component included in the electronic system or the technician's workbench. Furthermore the clamp-attachment element may releasably anchor the cable-retention element at a desired location to allow the clamp to be effectively reused many times.

By retaining a probe cable at a desired location, the clamp can isolate the probe cable away from the technician's activities and keep excess probe cable from looping. This reduces the likelihood of damage caused by the technician unintentionally pulling the probe cable while probing an electrical circuit and increases the fidelity of the signal the oscilloscope receives.

### BRIEF DESCRIPTION OF THE DRAWINGS

FIG. 1 is a perspective view of an electronic system that includes an electrical circuit being probed, and a probe cable secured to various structures of the electronic system by cable clamps according to an embodiment of the invention.

FIG. 2 is a perspective view with portions broken away of a probe-cable clamp in FIG. 1 according to an embodiment of the invention.

FIG. 3 is a perspective view of a probe-cable clamp according to another embodiment of the invention.

FIG. 4 is a perspective view of a probe-cable clamp in FIG. 1 according to another embodiment of the invention.

FIG. 5 is a side view of a probe-cable clamp according to yet another embodiment of the invention.

### DESCRIPTION OF THE PREFERRED EMBODIMENTS

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

FIG. 1 is a perspective view of an electronic system 10 that includes an electrical circuit 12 being probed by a probe 14. The probe 14 is connected to an oscilloscope 16 with a probe cable 18, and clamps 20 secure the probe cable 18 to the electronic system 10 out of the technician's way and prevent the probe cable 18 from looping. Consequently, the technician is less likely to snag or unintentionally pull the probe cable 18 and thus, less likely to damage the electronic system 10, probe 14, or oscilloscope 16 while probing the electronic system 10. Furthermore, the unlooped probe cable 18 is less likely to degrade the electrical signal sensed by the probe 14, and thus the technician can obtain a more accurate reading of the electrical signal in the electrical circuit 12.

Each clamp 20 includes a clamp-attachment element (discussed in greater detail elsewhere herein) for releasably anchoring the clamp to the electronic system 10. Thus, the clamp 20 can be anchored to a desired location on the electronic system 10 and later be reused to secure the clamp 20 at other desired locations on the same electronic system 10 or on a different electronic system. Alternatively, one or more of the clamps 20 may be designated for one-time use only. Each clamp 20 also includes a cable-retention element (also discussed in greater detail elsewhere herein) for releasably retaining the probe cable 18 to the clamp 20.

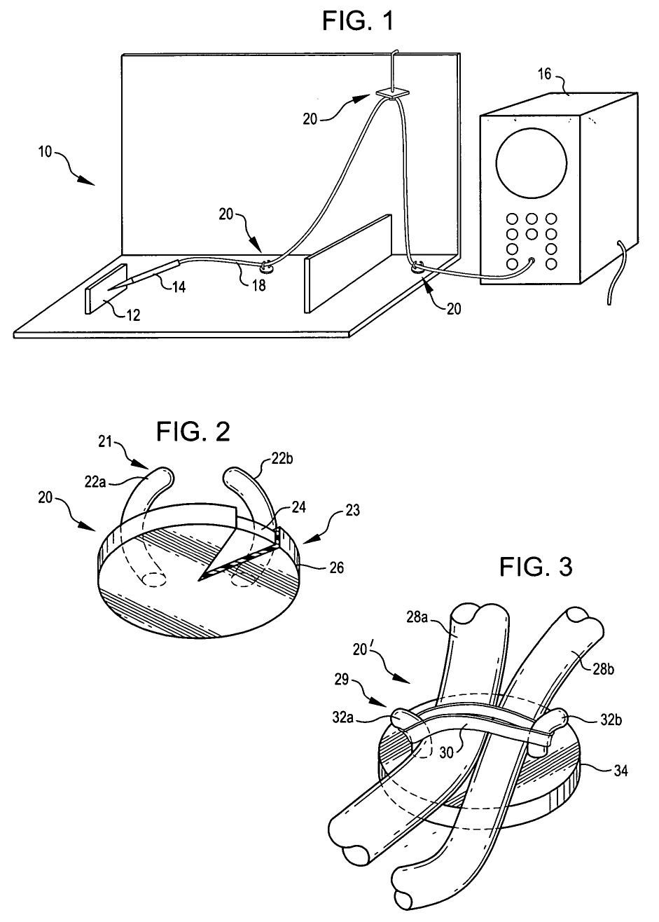

FIG. 2 is a perspective view of a first clamp 20 in FIG. 1, according to an embodiment of the invention. The cable-retention element 21 includes two arms 22a and 22b operable to hold a probe cable 18 in FIG. 1, and the clamp-attachment element 23 includes a magnet 24 for releasably retaining the clamp 20 to a portion of the electronic system 10 in FIG. 1, such as a protective case (not shown). The clamp 20 may also include a body 26 for housing the magnet 24 and to which the two arms 22a and 22b are mounted.

Each arm 22a and 22b releasably retains the probe cable 18 by receiving the probe cable 18 between each arm 22a and 22b. Each arm 22a and 22b is made from elastically deformable material, such as, any conventional metal, plastic, rubber or any combination of the three, and is fixed to the body 26 to prevent the rotation of each arm 22a and 22b relative to the body 26. Consequently, when a probe cable 18 is inserted between the arms 22a and 22b, the arms 22a and 22b hold the probe cable 18 to the clamp 20. To help hold a probe cable 18 between the arms 22a and 22b, each arm 22a and 22b also curves toward the other as each extends from the body 26. If the probe cable 18 is too thick to completely fit between the arms 22a and 22b, one or both of the arms 22a and 22b may elastically deform and thereby pinch the probe cable 18 between the arms 22a and 22b.

Alternatively, the arms 22a and 22b can extend from the body 26 in any desired manner. For example, the arms 22a and 22b can remain parallel or substantially parallel to each other as they extend from the body 26. Or, each arm 22a and 22b can include any desired material that can increase the friction between the arm and a probe cable 18 to help retain the probe cable 18 in situations where the arms hold the cable by pinching it. In other embodiments, each arm 22a and 22b can be pivotally attached to the body 26, and the cable-retention element 21 can include a closure for preventing the arms 22a and 22b from pivoting away from each other after a probe cable 18 has been inserted between them. In still other embodiments, the cable-retention element 21 can include more than two arms to retain a probe cable 18.

Still referring to FIG. 2, the clamp-attachment element 23 includes a magnet 24 for magnetically attaching the clamp 20 to an electronic system 10 in FIG. 1. The magnet 24 can be any desired magnet that generates enough magnetic force to anchor the clamp 20 and probe cable 18 to the electronic system 10.

Still referring to FIG. 2, the magnet 24 is encased in the body 26. In other embodiments, the magnet 24 can be attached to the body 26 or directly to the arms 22a and 22b using any desired fastening technique. For example, the magnet 24 can be glued to the body 26 or arms 22a and 22b with a conventional adhesive or using conventional mechanical fasteners such as a rivet, screw, or bolt and nut.

In other embodiments, the clamp 20 may be attached to an electronic system 10 in FIG. 1 using any other desired technique. For example, the clamp-attachment element 23 may include any desired adhesive. The adhesive may be a reusable adhesive or reusable putty that retains the clamp 20 to any desired location on an electronic system 10 and that remains with the clamp 20 when the clamp 20 is removed from the electronic system 10 to be reused. Alternatively, a permanent adhesive may be used. Furthermore, the clamp-attachment element 23 may also include Velcro® to releasably anchor the clamp 20 to the electronic system 10.

Still referring to FIG. 2, the body 26 can be made of any desired material. For example, the body 26 can be made of conventional thermoplastic polymers formed around the magnet 24 by injecting the polymer into a mold. With the body 26 made of plastic, the clamp 20 is less likely to create a short in the electronic system 10 when used or accidentally dropped onto the system 10. In other embodiments, the body 26 can be made from other types of materials, such as, conventional metal or wood, and formed by other manufacturing processes, such as, stamping or machining. Alternatively, the body 26 can include a material that suppresses any excessive magnetic field generated by the magnet 24.

FIG. 3 is a perspective view of a clamp 20 that can retain one or more probe cables—here two probe cables 28a and 28b-according to another embodiment of the invention. The cable-retention element 29 includes a conventional rubber band 30 and two cleats 32a and 32b that extend from a body 34. With the rubber band 30, the clamp 20 can retain two or more probe cables 28a and 28b. This may be desirable when the technician probes the electronic system 10 in FIG. 1 with two or more probes. In addition, the clamp 20 can be used to retain a variety of probe cables having different diameters. For example, the clamp 20 could retain a probe cable having a diameter equal to the sum of the diameters of the probe cables 28a and 28b, or the clamp 20 could retain the probe cable 28a or 128b alone. This flexibility allows the technician to use the clamp 20 with probe cables having different diameters.

The clamp 20 may be attached to an electronic system 10 in FIG. 1 using any desired technique such as those described in conjunction with FIG. 2. The cleats 32a and 32b may be constructed and attached to the body 34 similar to the construction and attachment of the arms 22a and 22b in FIG. 2 to the body 26 in FIG. 2.

In other embodiments, the cable-retention element 29 can include two or more rubber bands, or three or more cleats.

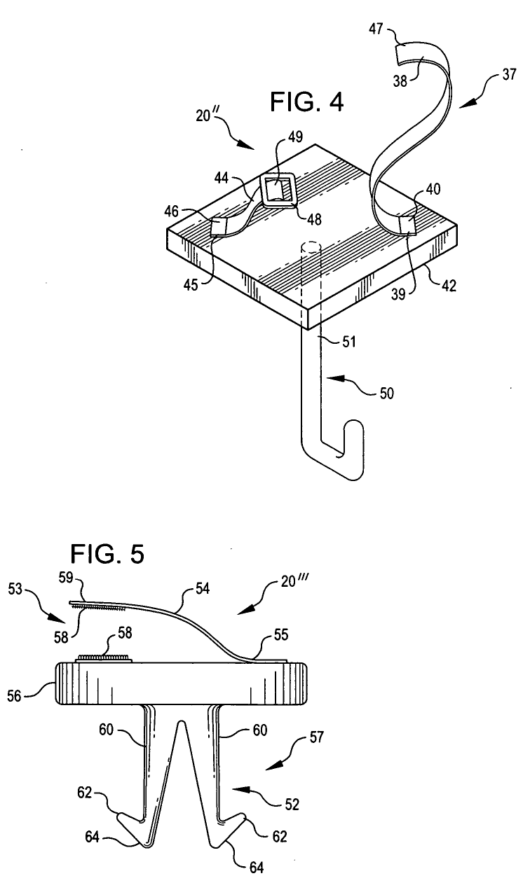

FIG. 4 is a perspective view of a hanging clamp 20 in FIG. 1 according to another embodiment of the invention. The cable-retention element 37 includes a first strap 38 having a first end 39 attached to a first location 40 on the body 42, a second strap 44 having a first end 45 attached to the body 42 at a second location 46, and a buckle 48 attached to a second end 49 of the second strap 44 and operable to attach the first strap 38 to the second strap 44. The clamp-attachment element 50 includes a hook 51 for suspending the clamp 20 from the electronic system 10 in FIG. 1. To retain a probe cable 18 (FIG. 1) with the straps 38 and 44, the probe cable 18 is placed between the first and second locations 40 and 46. The first strap 38 is then wrapped over the probe cable 18, and a second end 47 of the first strap 38 is inserted into the buckle 48. Similar to the rubber band 30 in FIG. 3, the straps 38 and 44 allow the clamp 20 to retain two or more probe cables or a variety of probe cables having different diameters.

The hook 51 provides another means for releasably anchoring the body 42 to the electronic system 10 in FIG. 1. The hook 51 can engage an edge of a circuit board or protective case of the electronic system 10 in FIG. 1 or the hook 51 can be inserted into a hole in a circuit board or protective case of the system 10. In one embodiment, the hook 51 has a fixed length and is constructed and attached to the body 42 similar to the construction and attachment of the arms 22a and 22b in FIG. 2 to the body 16 in FIG. 2. In other embodiments, the hook's length can be adjustable.

Still referring to FIG. 4, the straps 38 and 44 are conventionally attached to the body 42 such as with a conventional adhesive, or with a fastener such as, a rivet, screw, nut and bolt, or thread.

In other embodiments of the clamp 20, the cable-retention element 37 can include more than one first and corresponding second straps 38 and 44 with a buckle 48 to retain a probe cable. In still other embodiments of the clamp 20, the first and second straps 38 and 44 can be attached to each other with Velcro®.

FIG. 5 is a side view of a clamp 20 according to another embodiment of the invention. A clamp-attachment element 57 includes an expansion pin 52 that can be inserted into a receptacle (not shown in FIG. 1) of the electronic system 10 in FIG. 1 for releasably anchoring the clamp 20 at a desired location on the system 10. A cable-retention element 53 includes a strap 54 having a first end 55 attached to a body 56 and Velcro® strips 58 for releasably retaining a probe cable 18 in FIG. 1 to the clamp 20. One of the Velcro® strips 58 is attached to a second end 59 of the strap 54 and another of the Velcro® strips 58 is attached to the body 56.

The expansion pin 52 can be inserted into different sized receptacles—typically holes having different diameters in a circuit board of the electronic system 10—to allow a technician to use and reuse the clamp 20 at a number of desirable locations. The expansion pin 52 includes two legs 60 each extending from the body 56 of the clamp 20. Each leg 60 is elastically deformable when the legs are pinched together and each includes a latch 62 at a distal end 64. The distal ends 64 are configured to allow the respective legs 60 to be inserted into a hole in the electronic system 10 with little or moderate pressure. As the legs 60 are inserted into a hole, the edge of the hole forces one or both legs 60 toward each other. Once, the hole passes a latch 62, the elastically deformable material causes the legs 60 to move away from each other. Thus, each latch 62 prevents one of the respective legs 60 from being removed from the hole by merely pulling the clamp 20. Consequently, to release the clamp from the electronic system 10, a technician must pinch the legs 60 together so that the latches 62 can pass through the hole.

In other embodiments the latches 62 can be configured to allow removal of the clamp 20 by pulling on the clamp 20 with force sufficient to move the legs 60 toward each other. Alternatively, the expansion pin 52 can include a shaft with a flexible ridge extending from the shaft that allows the shaft to be inserted into a hole in an electronic system with less force than is required to remove the shaft.

In still other embodiments of the clamp 20, other mounting techniques may be used as desired. Furthermore, the clamp 20 may include Velcro® to releasably anchor the clamp 20 to an electronic system 10 and to releasably retain a probe cable 18 to the clamp 20. In such an embodiment, the clamp 20 may not include a body.

1. (Cancelled)

2. A clamp for retaining a probe cable at a desired location while probing an electronic system with a probe, comprising:
a cable-retention element for releasably holding a probe cable; and
a clamp-attachment element for releasably anchoring the cable-retention element at a desired location.

3. The clamp of claim 2 wherein the clamp-attachment element includes a magnet.

4. The clamp of claim 2 wherein the clamp-attachment element includes a body and a magnet disposed inside the body.

5. The clamp of claim 2 wherein the clamp-attachment element includes an adhesive.

6. The clamp of claim 1 wherein the clamp-attachment element includes a hook.

7. The clamp of claim 1 wherein the clamp-attachment element includes a Velcro® strip.

8. The clamp of claim 1 wherein the clamp-attachment element includes an expansion pin insertable into a receptacle of an electronic system.

9. The clamp of claim 2 wherein the cable-retention element includes two arms that hold the probe cable when the probe cable is inserted between the arms.

10. The clamp of claim 2 wherein the cable-retention element includes two arms, each extending from the clamp-attachment element and, when a probe cable is inserted between them, spread apart to hold the probe cable.

11. The clamp of claim 10 wherein each arm curves toward the other arm as each arm extends from the clamp-attachment element.

12. The clamp of claim 1 wherein the cable-retention element includes a strap having a first end attached to the clamp-attachment element and a second end releasably attachable to the clamp-attachment element.

13. The clamp of claim 12 wherein the strap includes elastic material.

14. The clamp of claim 1 wherein the cable-retention element includes:
a first strap having a first and a second end, wherein the first end is attached to a first location on the clamp-attachment element;
a second strap having a first end attached to a second location on the clamp-attachment element and a second end releasably attachable to the second end of the first strap.

15. A probe system comprising:
a probe for sensing electrical signals within an electrical system;
a cable attached to the probe and operable to convey the electrical signals to an electrical signal processing device; and
a clamp including a cable-retention element for holding a probe cable and a clamp-attachment element for releasably anchoring the cable-retention element at a desired location.

16. The probe system of claim 15 wherein the electrical signal processing device includes an oscilloscope.

17. A method of retaining a probe cable at a desired location while probing an electronic system with a probe, the method comprising:
releasably anchoring a clamp to an electronic system at a desired location; and
releasably retaining a probe cable to the clamp.

18. The method of claim 17 wherein anchoring the clamp includes magnetically coupling the clamp to the electronic system.

19. The method of claim 17 wherein anchoring the clamp includes adhering the clamp to the electronic system with an adhesive.

20. The method of claim 17 wherein anchoring the clamp includes suspending the clamp from the electronic system.

21. The method of claim 17 wherein anchoring the clamp includes inserting an expansion pin of the clamp into a receptacle in the electronic system.

22. The method of claim 17 wherein releasably retaining the probe cable to the clamp includes inserting the probe cable between two arms of the clamp.

23. The method of claim 17 wherein releasably retaining the probe cable to the clamp includes releasably attaching an end of a strap to a clamp-attachment element of the clamp.

24. The method of claim 17 wherein releasably retaining the probe cable to the clamp includes releasably attaching an end of a strap to a clamp-attachment element of the clamp with Velcro®.

25. The method of claim 17 further comprising:
releasing the clamp from the electronic system;
moving the clamp to another desired location; and
releasably anchoring the clamp at the new desired location.

26. The method of claim 17 further comprising:
releasing the probe cable from the clamp;
releasing the clamp from the electronic system;
moving the clamp to another desired location;
releasably anchoring the clamp at the new desired location; and
releasably retaining the probe cable to the clamp.
